(19) United States
(12) Patent Application Publication
(10) Pub. No.: US 2008/0104070 A1
(43) Pub. Date: May 1, 2008

(54) PATTERN-BASED FILTERING OF QUERY INPUT

(75) Inventor: Bart Lonchar, Portland, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: IOVATION, INC., Portland, OR (US)

(21) Appl. No.: 11/923,580

(22) Filed: Oct. 24, 2007

Related U.S. Application Data
(60) Provisional application No. 60/862,966, filed on Oct. 25, 2006.
(60) Provisional application No. 60/862,960, filed on Oct. 25, 2006.

(51) Int. Cl. G06F 17/30

(52) U.S. Cl. 707/6; 707/E17.014

(57) ABSTRACT

Methods, apparatuses, and articles for receiving, by a computing device, a search request, the search request specifying an outcome type and one or more candidate query parameter values are described herein. The computing device may also select some or all of the candidate query parameter values by filtering the candidate query parameter values in view of a plurality of patterns associated with the outcome type to facilitate querying of a database with the selected query parameter values.

### RELATED APPLICATIONS

The present application claims priority to U.S. Provisional Application 60/862,966, entitled “Pattern Matching Engine”, filed on Oct. 25, 2006 and U.S. Provisional Application 60/862,960, entitled “Device Identification Using Pattern Matching Engine”, filed on Oct. 25, 2006. The specifications of the 60/862,966 and 60/862,960 provisional applications are hereby incorporated by reference in their entirety for all purposes, except for those sections, if any, that are inconsistent with this specification.

### FIELD OF THE INVENTION

The present invention relates to the field of data processing, in particular to pattern based-filtering of candidate query parameter values.

### BACKGROUND OF THE INVENTION

Often, systems use a database management system (DBMS) to do efficient lookups based on one or more key values, where the attributes that comprise the key are known ahead of time and defined into the structure of the database. When systems need to perform lookups based on complex variable patterns, most solutions employ either embedded logic (rules) in the lookup, or formulas for combining data from multiple lookups. Logic-based and formula-based solutions often require code changes when patterns need to be defined or augmented. Also, they require the execution of more instructions on the computer and generally require more data to be read due to the distribution of relevant data across the system.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of various embodiments of the present invention;

FIG. 2 illustrates a flowchart view of selected operations, in accordance with various embodiments;

FIG. 3 illustrates a Venn diagram representation of pattern matching operations, in accordance with various embodiments; and

FIG. 4 is a block diagram illustrating an example computer system suitable for use to practice the present invention, in accordance with various embodiments.

### DETAILED DESCRIPTION OF EMBODIMENTS OF THE INVENTION

Illustrative embodiments of the present invention include, but are not limited to, methods and apparatuses for receiving, by a computing device, a search request, the search request specifying an outcome type and one or more candidate query parameter values. The computing device may also select some or all of the candidate query parameter values by filtering the candidate query parameter values in view of a plurality of patterns associated with the outcome type to facilitate querying of a database with the selected query parameter values.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

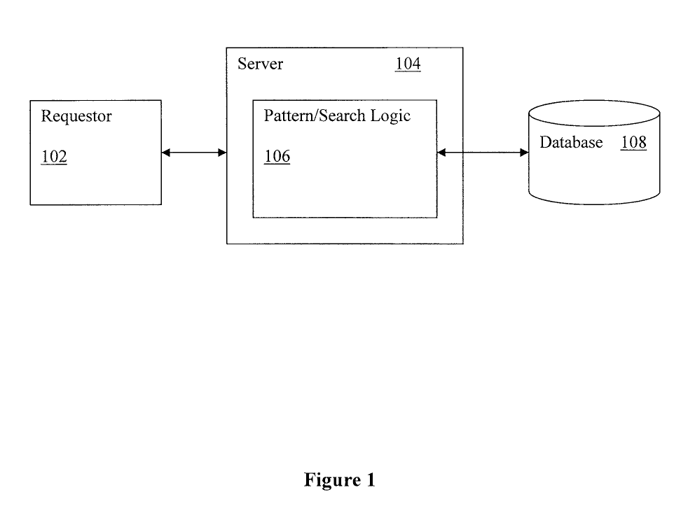

FIG. 1 illustrates an overview of various embodiments of the present invention. As illustrated, a server 104 may receive a search request from a requester 102, the request identifying a sought outcome type and one or more candidate query parameter values selected by the requester as being potentially relevant to the outcome type. Upon receiving the request, server 104 may invoke pattern matching and searching/querying logic 106 (hereinafter, “logic 106”). Logic 106 may select one or more of the candidate query parameter values by filtering the candidate query parameter values in view of a plurality of patterns associated with the outcome type. In some embodiments, logic 106 may then query a database 108 with the selected query parameter values and their associated types to determine one or more outcomes associated with the outcome type. Server 104 may then provide the one or more outcomes, or a subset thereof, to requestor 102.

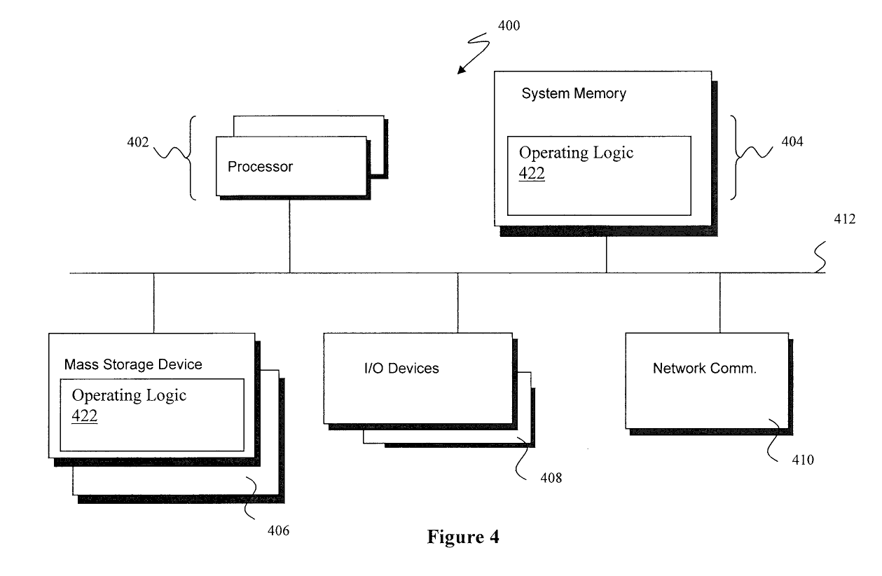

As illustrated, requester 102 and/or server 104 may each be one or more of any sort of computing device known in the art, except for logic 106, and other logic adapted to perform the operations described more fully herein. Requestor 102 and/or server 104 may each be a personal computer (PC), a workstation, a server, a router, a mainframe, a modular computer within a blade server or high-density server, a personal digital assistant (PDA), an entertainment center, a set-top box or a mobile device. Further, requester 102 and/or server 104 may each be any single- or multi-processor or processor core central processing unit (CPU) computing system known in the art, except for logic 106, and other logic adapted to perform the operations described more fully herein. An exemplary single-/multi-processor or processor core requester 102 and/or server 104 is illustrated by FIG. 4, and will be described in greater detail herein.

As previously mentioned, requester 102 may issue a search request to server 104 for a specific outcome type. For example, requestor 102 may seek the identity of a computing device. Such a requester 102 may specify “device identifier” as the sought outcome type.

Requestor 102 may also include in the request one or more candidate query parameter values. In some embodiments, requestor 102 may include both candidate query parameter values and their associated types as a set of name/value pairs. For example, a requester 102 seeking a device identifier might include one or more candidate query parameter values corresponding to the following query parameter types: token, media access control address (MACA), WIND, WPID, HDID, IEID, an account identifier (ACCT), a service provider identifier (ISP), a city, a region, a country, or a time zone. Of these types, MACA, WIND, WPID, HDID, IEID are known in the art. Types such as ACCT or ISP may be associated with a service subscription of a computing device whose identity is sought. Types such as a city, a region, a country, or a time zone may be associated with a location of a computing device whose identity is sought. A token type may be a device identifier which may have uniquely identified, at one point in time, a computing device whose identity is sought. Such tokens are described in greater detail in U.S. patent application Ser. No. ______, entitled “Creating and Verifying Globally Unique Device-Specific Identifiers”, filed on Oct. 24, 2007.

In some embodiments, requester 102 may also include in the request a minimum weight threshold and a maximum number of outcomes. Each outcome may be associated with a weight, as will be described more fully herein, and requester 102 may specify a threshold to narrow the number and/or quality of outcomes received from server 104. Requestor 102 may also specify a maximum number of outcomes to narrow the number of outcomes received. In various embodiments, requester 102 may be a synchronous or asynchronous process, and, upon issuing the request, may or may not wait for a response from server 104. At some point in time after issuing the request, requester 102 may receive an array of outcomes and, in one embodiment, their associated weights, from server 104.

In various embodiments, requestor 102 may be a subscriber to a service offered by server 104, and may itself interact with other end-user computing devices. In one embodiment, requestor 102 may seek the identity of one of these end-user devices, identifying the device identifier of the computing device of interest as the outcome type, and providing a number of descriptors of the computing device as query parameter values.

In some embodiments, requestor 102 and server 104 may actually reside on the same computing device and may be server and client processes of that device. In other embodiments, and as described throughout for the sake of illustration, requestor 102 and server 104 may be separate, remotely disposed computing devices. In various embodiments, where requestor 102 is remotely disposed from server 104, requestor 102 and server 104 may be communicatively connected to each other. In some embodiments, requestor 102 and server 104 may be connected by a networking fabric (not illustrated). Such a networking fabric may include one or more of a LAN, a WAN, and the Internet, as is known in the art.

As illustrated, and as previously mentioned, server 104 may include logic 106 for generating patterns, for filtering based on those patterns to select query parameter values, for querying database 108 with the selected values, and for receiving outcomes from the query. Server 104 may comprise one or more computing devices, as previously mentioned, and, in one embodiment, logic 106 may be a distributed process dispersed across multiple computing devices of server 104. In some embodiments, server 104 may also include database 108. In other embodiments, database 108 may be located on another, remotely disposed computing device, such as a database server.

In various embodiments, logic 106 may be any single-threaded or multi-threaded process located entirely or partially on server 104. Logic 106 may first be invoked by server 104, via, for example, a function call, in response to receipt by server 104 of a search request from requestor 102. Contents of exemplary search requests were previously described in greater detail. Upon being invoked, logic 106 may first determine the outcome type included in the request, by, for example, parsing the request. Once the outcome type is determined, logic 106 may either generate patterns associated with the outcome type, or retrieve previously generated patterns associated with the outcome type.

In some embodiments, logic 106 may generate a plurality of patterns by statistically correlating the outcome type with combinations of query parameter types in view of historical data evidencing associations of the outcome type with ones of the combinations. In one embodiment, each pattern of the plurality of patterns may comprise one or more query parameter types. Combinations of query parameter types may be formed by logic 106 based on some logical correlation between query parameter types. For example, all parameter types describing a location may form one combination. Once combinations are formed, they may be statistically correlated with the outcome type in view of historical data. The historical data may be retrieved by logic 106 from database 108 or from some other remote or local source storing descriptions of associations between outcome types and combinations of query parameter types. For example, the correlation may comprise selecting as patterns all combinations that have previously determined an outcome of the outcome type having a weight value exceeding a pre-determined threshold. This is simply one method among many of generating patterns. Numerous other methods may also or instead be used, such as machine learning tools or schema-based analysis. In one embodiment, the plurality of generated patterns may include at least one of a first pattern comprising a token, a second pattern comprising a MACA and a WIND, a third pattern comprising a WIND, a WPID, an HDID, and an IEID, a fourth pattern comprising an account identifier and a service provider identifier, or a fifth pattern comprising a city, a country, a region, and a time zone.

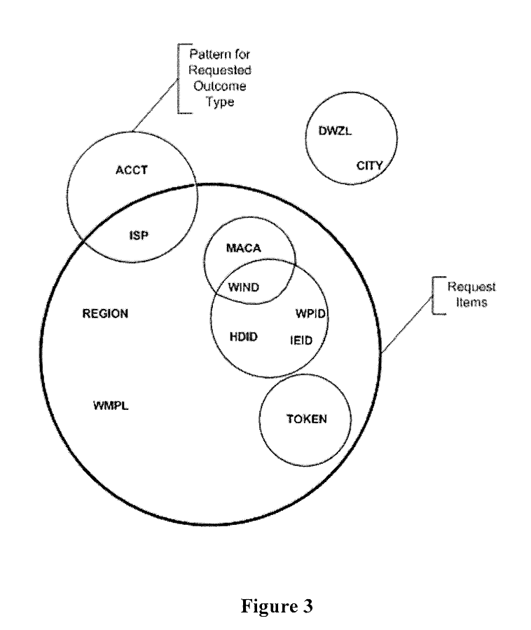

In various embodiments, upon generating or retrieving patterns, logic 106 may utilize the patterns to filter and select from one or more candidate query parameter values included in the request. Logic 106 may first parse the request to determine whether the request includes both parameter types and values as name/value pairs, or only included candidate query parameter values. If only values are included, logic 106 may analyze the values to determine which types they are likely associated with. Once the query parameter types associated with the candidate query parameter values may been retrieved or determined, logic 106 may filter the query parameter types in view of the patterns, the filtering including intersecting query parameter types of the candidate query parameter values with the query parameter types of the patterns to determine a set of query parameter types which correspond to intersections and for which all query parameter types of a pattern are found to intersect with query parameter types of the candidate query parameter values. FIG. 3 illustrates a Venn diagram of the intersecting and set-determining, and will be described in greater detail herein. As illustrated in FIG. 3, query parameter types may be determined to be part of the set if they belong to a pattern for which each type of the pattern was found in the request. Query parameter types of the request which do not intersect with any pattern may not be included in the set, in some embodiments. Once logic 106 has determined the set of query parameter types, it may form name/value pairs of those types and their associated candidate query parameter values (the formed name value pairs referred to hereinafter as a “signature”).

In some embodiments, upon determining/selecting the signatures, logic 106 may generate a query comprising the signatures and the outcome type. Logic 106 may then make the query of database 108. Logic 106 may query database 108 for exact matches of name/value pairs of the signatures with name/value pairs associated by database 108 with outcomes, those outcomes comprising the query results. In one embodiment, a weight value for each outcome may also be a result. In various implementations, the querying may be performed efficiently by logic 106 utilizing an Oracle DBMS execution plan that may do the lookup in an single optimized query, rather than a series of lookups for each name/value pair of the signatures. To accomplish this, logic 106 may store the signatures in a global temporary table with pre-set dictionary statistics and may use a query that utilizes a NO_HASH hint to result in an execution plan equivalent in performance to a direct lookup. In various embodiments, the query may be formed using any query language known in the art, such as SQL. In other embodiments, rather than generating the query itself, through logic 106, server 104 may provide the signatures to another computing device to formulate a query.

In one embodiment, where database 108 is remotely disposed from server 104, server 104 and database 108 may be communicatively connected to each other. In some embodiments, server 104 and database 108 may be connected by a networking fabric (not illustrated). Such a networking fabric may include one or more of a LAN, a WAN, and the Internet, as is known in the art.

As illustrated, logic 106, at some point in time after making a query, may receive a plurality of outcomes from database 108 as query results. As previously mentioned, the query results may further comprise a weight value for each outcome. If weight values for outcomes are included, logic 106 may determine if any of the outcomes are identical. For identical outcomes, such as a first outcome device 1 with a weight value of 8 and a second outcome device 1 with a weight value of 24, logic 106 may accumulate/aggregate the weight values, arriving at one combined outcome with an aggregated weight value, such as combined outcome device 1 with a weight value of 32. In one embodiment, the accumulating/aggregating may comprise adding the weight values, and the aggregated weight value may comprise a totaled weight value.

Logic 106 may then examine the search request to determine if the request specified a weight threshold or a maximum number of outcomes. In some embodiments, if no threshold or maximum is specified, logic 106 may simply provide requestor 102 with all outcomes received in the query result (and their weight values, if included in the result). In other embodiments, logic 106 may use a default threshold and a default maximum number of outcomes, and may operate in the same manner as if the search request had specified the threshold and maximum.

In various embodiments, logic 106 may proceed to compare the weight values/aggregated weight values of the outcomes/combined outcomes with the weight threshold specified or provided by default. In a first embodiment, any outcome with a weight value less than the threshold may not be included in the search results. In a second embodiment, any outcome with a weight value more than the threshold may not be included in the search results. For example, if the threshold is 12, the previously mentioned combined outcome with a weight of 32 may be included in the first embodiment. Logic 106 may then determine whether the number of remaining outcomes exceeds the maximum number specified or provided by default. If the maximum number is exceeded, logic 106 may, in one embodiment, not include in the search results a number of outcomes with the lowest weight values, that number equal to the difference between the number of remaining outcomes and the maximum number, with what is considered “lowest” varying from embodiment to embodiment. In another embodiment, the number of outcomes with the highest weight values may not be included, with what is considered “highest” varying from embodiment to embodiment. After reducing the outcomes based on the threshold and/or maximum number, logic 106 may provide the remaining outcomes and their weight values as an array of outcome/weight value pairs, as previously mentioned.

As is shown, database 108 may be any sort of database known in the art, except for its internal structuring (e.g., tables) and data. Database 108 may be a relational database, a normalized database, a de-normalized database, or a file. In various embodiments, database 108 may store a plurality of outcomes for a plurality of outcome types. Database 108 may also include one or more tables associating outcomes with query parameter values, with outcomes in a column specified by an outcome type, and query parameter values in a column specified by a query parameter type. Database 108 may further include a plurality of other tables containing data necessary to facilitate the previously described operations of logic 106, capable of providing results for queries formulated by logic 106. In one embodiment, database 108 may also store the previously mentioned historical data to facilitate logic 106 in generating the plurality of patterns.

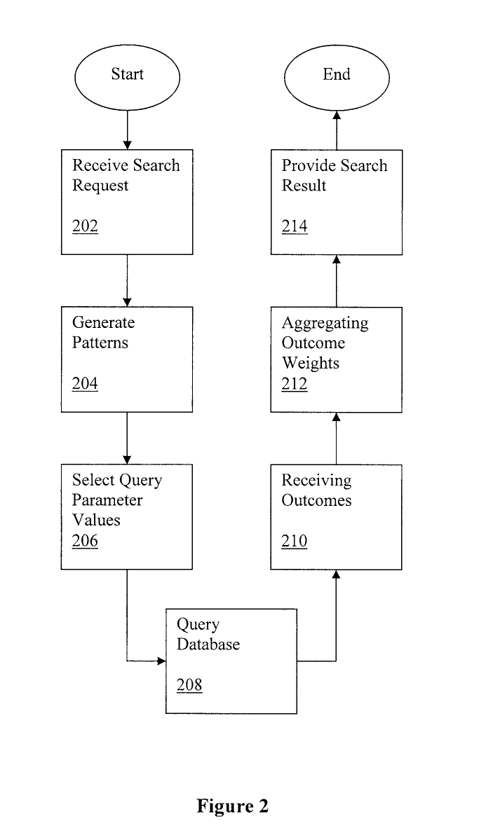

FIG. 2 illustrates a flowchart view of selected operations, in accordance with various embodiments. As illustrated, a computing device, such as search server 104, may receive a search request, block 202, the search request specifying an outcome type and one or more candidate query parameter values. In some embodiments, the computing device may then (or at a prior time, as previously mentioned) generate a plurality of patterns, block 204, by statistically correlating the outcome type with combinations of query parameter types in view of historical data evidencing associations of the outcome type with ones of the combinations. In one embodiment, each pattern of the plurality of patterns may comprise one or more query parameter types. The plurality of patterns may include at least one of a first pattern comprising a token, a second pattern comprising a MACA and a WIND, a third pattern comprising a WIND, a WPID, an HDID, and an IEID, a fourth pattern comprising an account identifier and a service provider identifier, or a fifth pattern comprising a city, a country, a region, and a time zone.

In various embodiments, the computing device may then select some or all of the candidate query parameter values, block 206, by filtering the candidate query parameter values in view of a plurality of patterns associated with the outcome type to facilitate querying of a database with the selected query parameter values. In some embodiments, the filtering may include intersecting query parameter types of the candidate query parameter values with the query parameter types of the patterns to determine a set of query parameter types which correspond to intersections and for which all query parameter types of a pattern are found to intersect with query parameter types of the candidate query parameter values, and the selecting may include selecting candidate query parameter values associated with query parameter types of the determined set.

As illustrated, the computing device may then query the database with the selected query parameter values and their associated types, block 208, to determine one or more outcomes associated with the outcome type. In response, the computing device may receive an outcome for each of the selected query parameter values and an associated weight value for each outcome, block 210, and may aggregate the weight values of identical outcomes, block 212. In some embodiments, the computing device may then provide a response to the search request, block 214, the response including at most a maximum number of outcomes and only including outcomes with a weight value that is greater in magnitude than a pre-defined threshold, the maximum number and the pre-defined threshold having been specified in the search request.

FIG. 3 illustrates a Venn diagram representation of pattern matching operations, in accordance with various embodiments. As illustrated, a plurality of patterns may be intersected with query parameter types associated with candidate values provided in a received search request. In the diagram, the search request is represented by the largest circle and the patterns are each represented by one of the other circles. Each pattern includes one or more query parameter types. For example, the patterns illustrated include first pattern comprising a token, a second pattern comprising a MACA and a WIND, a third pattern comprising a WIND, a WPID, an HDID, and an IEID, a fourth pattern comprising an account identifier (ACCT) and a service provider identifier (ISP), or a fifth pattern comprising a city and a DWZL. The illustrated search request includes, as an example, the following query parameter types corresponding to the candidate values of the request: a token, a MACA, a WIND, a WPID, an HDID, an IEID, an ISP, a region, and a WMPL. As previously mentioned, a server 104 may intersect the patterns and query parameter types to determine a set of query parameter types which corresponds to the intersections and for which all query parameter types of a pattern are found to intersect with query parameter types of the candidate values. In FIG. 3, the set comprises, as an example, the token, the MACA, the WIND, the WPID, the HDID, and the IEID types. While the ISP type does intersect with a query parameter type of a pattern, that pattern's other type, ACCT, does not intersect with query parameter type associated with the search request. Thus, the ISP type is not included in the set. As previously mentioned, candidate query parameter values associated with query parameter types of the determined set may then be utilized by a server 104 in a query of a database 108.

FIG. 4 is a block diagram illustrating an example computer system suitable for use to practice the present invention, in accordance with various embodiments. As shown, computing system 400 includes one or more processors or processor cores 402, and system memory 404. For the purpose of this application, including the claims, the terms “processor” and “processor cores” may be considered synonymous, unless the context clearly requires otherwise. Additionally, computing system 400 includes mass storage devices 406 (such as diskette, hard drive, compact disc read only memory (CDROM) and so forth), input/output devices 408 (such as keyboard, cursor control and so forth) and communication interfaces 410 (such as network interface cards, modems and so forth). The elements are coupled to each other via system bus 412, which represents one or more buses. In the case of multiple buses, they are bridged by one or more bus bridges (not illustrated).

Each of these elements performs its conventional functions known in the art. In particular, system memory 404 and mass storage 406 may be employed to store a working copy and a permanent copy of the programming instructions implementing all or a portion of earlier described functions, herein collectively denoted as 422. The instructions 422 may be assembler instructions supported by processor(s) 402 or instructions that can be compiled from high level languages, such as C.

The permanent copy of the programming instructions may be placed into permanent storage 406 in the factory, or in the field, through, for example, a distribution medium (not shown), such as a compact disc (CD), or through communication interface 410 (from a distribution server (not shown)). That is, one or more distribution media having instructions 422 may be employed to distribute the instructions 422 and program various computing devices.

The constitution of these elements 402-412 are known, and accordingly will not be further described.

In embodiments of the present invention (not illustrated), an article of manufacture may be employed to implement one or more methods as disclosed herein. For example, in exemplary embodiments, an article of manufacture may comprise a storage medium and a plurality of programming instructions stored in the storage medium and adapted to program an apparatus to enable the apparatus to receive a search request, the search request specifying an outcome type and one or more candidate query parameter values. In various ones of these embodiments, programming instructions may be adapted to select query parameter values by filtering the one or more candidate query parameter values in view of a plurality of patterns associated with the outcome type. In various embodiments, programming instructions may be adapted to query a database with the selected query parameter values to determine one or more outcomes.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. Those skilled in the art will readily appreciate that the present invention may be implemented in a very wide variety of embodiments or extended therefrom. This application is intended to cover any adaptations or variations of the embodiments discussed herein. Therefore, it is manifestly intended that this invention be limited only by the claims and the equivalents thereof.

What is claimed is:

1. A method comprising:
receiving, by a computing device, a search request, the search request specifying an outcome type and one or more candidate query parameter values;
selecting, by the computing device, some or all of the candidate query parameter values by filtering the candidate query parameter values in view of a plurality of patterns associated with the outcome type to facilitate querying of a database with the selected query parameter values.

2. The method of claim 1, wherein each pattern of the plurality of patterns comprises one or more query parameter types.

3. The method of claim 2, wherein the plurality of patterns include at least one of a first pattern comprising a token, a second pattern comprising a MACA and a WIND, a third pattern comprising a WIND, a WPID, an HDID, and an IEID, a fourth pattern comprising an account identifier and a service provider identifier, or a fifth pattern comprising a city, a country, a region, and a time zone.

4. The method of claim 2, wherein the filtering includes intersecting query parameter types of the candidate query parameter values with the query parameter types of the patterns to determine a set of query parameter types which correspond to intersections and for which all query parameter types of a pattern are found to intersect with query parameter types of the candidate query parameter values, and the selecting includes selecting candidate query parameter values associated with query parameter types of the determined set.

5. The method of claim 2, further comprising generating, by the computing device, the plurality of patterns by statistically correlating the outcome type with combinations of query parameter types in view of historical data evidencing associations of the outcome type with ones of the combinations.

6. The method of claim 1, further comprising querying, by the computing device, the database with the selected query parameter values and their associated types to determine one or more outcomes associated with the outcome type.

7. The method of claim 6, further comprising
receiving, by the computing device, an outcome for each of the selected query parameter values and an associated weight value for each outcome, and
aggregating, by the computing device, the weight values of identical outcomes.

8. The method of claim 7, further comprising providing, by the computing device, a response to the search request, the response including at most a maximum number of outcomes and only including outcomes with a weight value that is greater in magnitude than a pre-defined threshold, the maximum number and the pre-defined threshold having been specified in the search request.

9. An apparatus comprising:
a processor; and
logic to be operated by the processor to
receive a search request, the search request specifying an outcome type and one or more candidate query parameter values,
select query parameter values by filtering the one or more candidate query parameter values in view of a plurality of patterns associated with the outcome type,
query a database with the selected query parameter values to determine one or more outcomes.

10. The apparatus of claim 9, wherein each pattern of the plurality of patterns comprises one or more query parameter types.

11. The apparatus of claim 10, wherein the plurality of patterns include at least one of a first pattern comprising a token, a second pattern comprising a MACA and a WIND, a third pattern comprising a WIND, a WPID, an HDID, and an IEID, a fourth pattern comprising an account identifier and a service provider identifier, or a fifth pattern comprising a city, a country, a region, and a time zone.

12. The apparatus of claim 10, wherein the logic is to
said filter, and the filtering further includes intersecting query parameter types of the candidate query parameter values with the query parameter types of the patterns to determine a set of query parameter types which correspond to intersections and for which all query parameter types of a pattern are found to intersect with query parameter types of the candidate query parameter values, and
said select, and the selecting further includes selecting candidate query parameter values associated with query parameter types of the determined set.

13. The apparatus of claim 10, wherein the logic is further to generate the plurality of patterns by statistically correlating the outcome type with combinations of query parameter types in view of historical data evidencing associations of the outcome type with ones of the combinations.

14. The apparatus of claim 9, wherein the logic is to said query, and the querying comprises querying the database with the selected query parameter values and their associated types to determine the one or more outcomes, the outcomes being associated with the outcome type.

15. The apparatus of claim 14, wherein the logic is further to
receive an outcome for each of the selected query parameter values and an associated weight value for each outcome, and
aggregate the weight values of identical outcomes.

16. The apparatus of claim 15, wherein the logic is further to provide a response to the search request, the response including at most a maximum number of outcomes and only including outcomes with a weight value that is greater in magnitude than a pre-defined threshold, the maximum number and the pre-defined threshold having been specified in the search request.

17. An article of manufacture comprising:
a storage medium; and
a plurality of programming instructions stored on the storage medium to configured to enable an apparatus to
receive a search request, the search request specifying an outcome type and one or more candidate query parameter values,
select query parameter values by filtering the one or more candidate query parameter values in view of a plurality of patterns associated with the outcome type,
query a database with the selected query parameter values to determine one or more outcomes.

18. The article of claim 17, wherein each pattern of the plurality of patterns comprises one or more query parameter types.

19. The article of claim 18, wherein the plurality of patterns include at least one of a first pattern comprising a token, a second pattern comprising a MACA and a WIND, a third pattern comprising a WIND, a WPID, an HDID, and an IEID, a fourth pattern comprising an account identifier and a service provider identifier, or a fifth pattern comprising a city, a country, a region, and a time zone.

20. The article of claim 18, wherein the programming instructions are further configured to enable the apparatus to
said filter, and the filtering further includes intersecting query parameter types of the candidate query parameter values with the query parameter types of the patterns to determine a set of query parameter types which correspond to intersections and for which all query parameter types of a pattern are found to intersect with query parameter types of the candidate query parameter values, and
said select, and the selecting further includes selecting candidate query parameter values associated with query parameter types of the determined set.
